(19) United States
(12) Patent Application Publication
(10) Pub. No.: US 2026/0296019 A1
(43) Pub. Date: Oct. 1, 2026

(54) ELECTRIC AND HYDRAULIC CONNECTIONS FOR PRINTHEAD

(71) Applicant: Dover Europe Sàrl, Vernier (CH)

(72) Inventors: Damien Bonneton, Hostun (FR); Jean-François Abadie, Bourg de Péage (FR); Camille Gobin, Lyon (FR); Manuel Thomet, Liebefeld (CH)

(21) Appl. No.: 19/480,336

(22) PCT Filed: May 2, 2025
(86) PCT No.: PCT/EP2024/062096

§ 371 Date: Oct. 30, 2025

Related U.S. Application Data
(60) Provisional application No. 63/499,625, filed on May 2, 2023.

(51) Int. Cl. B41J 2/165; B41J 2/02; B41J 2/175; B41J 25/34; B41J 29/02

(52) U.S. Cl. CPC B41J 2/16502; B41J 2/02; B41J 2/175; B41J 25/34; B41J 29/02

(57) ABSTRACT

An inkjet printer includes a printer body and a printhead. The printhead includes a main portion and a removable portion. At least one of the main portion and the removable portion includes a removable sealing member and a removable protective plate.

### BACKGROUND

This specification relates to inkjet printers, such as continuous inkjet printers. There are different continuous inkjet printing technologies.

US 2010/0045753 describes inkjet printing based on selective deviation of drops relative to a flow. A drop generator can generate either jet segments that are deflected by deflection electrodes and recovered, or drops that are not deflected and are printed on a substrate. Super piezo inkjet (SPI) printers can be based on a binary deflected continuous jet of non-charged drops or segments. Other binary printers can be based on other methods to deflect unprinted drops, such as charge or airflow.

WO 2022/144430 describes continuous inkjet (CIJ) printers. Some CIJ printers generate drops that are charged by charge electrodes and deflected by deflection electrodes. The charge of the drops determines their deflection by the deflection electrodes and hence the positioning of the drops on the substrate. Unprinted drops are recovered by a gutter and sent back to an ink tank.

WO 2009/049130 describes a print head assembly that has a chamber and a droplet generator module. The droplet generator module can be independently replaceable. A seal can be disposed between the ink droplet generator and the chamber.

### SUMMARY

This specification describes electrical and hydraulic connections for a printhead of an inkjet printer.

In general, one or more aspects of the subject matter described in this specification can be embodied in one or more systems that include an inkjet printer including a printer body and a printhead coupled with the printer body. The printhead includes a main portion and a removable portion. The main portion includes one or more fluid supply conduits to carry at least ink for the inkjet printer, first fluid interface conduits coupled with the one or more fluid supply conduits, first electronics, and a first electronics interface coupled with the first electronics. The removable portion includes second fluid interface conduits, second electronics, and a second electronics interface coupled with the second electronics. The first and second electronics interfaces are configured and arranged to connect to each other, thereby forming electrical connections between the first and second electronics, when the removable portion is attached to the main portion. At least one of the main portion and the removable portion includes a removable sealing member and a removable protective plate for that given portion of the printhead. The removable sealing member includes a flat portion and protruding portions, the protruding portions being aligned with the first and second fluid interface conduits such that the protruding portions form sealed hydraulic connections between the first and second fluid interface conduits when the removable portion is attached to the main portion. The removable protective plate is positioned over the flat portion of the removable sealing member when the removable protective plate is attached to the given portion of the printhead. The removable protective plate remains attached to the given portion of the printhead when the removable portion is not attached to the main portion. The removable protective plate defines holes through which the protruding portions of the removable sealing member pass when the removable protective plate is attached to the given portion of the printhead.

These and other embodiments can optionally include one or more of the following features. The removable protective plate can also be positioned over the electronics of the given portion of the printhead when the removable protective plate is attached to the given portion of the printhead. The removable protective plate can define an additional hole into which the electronics interface of the given portion of the printhead is positioned when the removable protective plate is attached to the given portion of the printhead.

The removable protective plate can include positioning protrusions or define holes for positioning protrusions. The positioning protrusions can ensure proper alignment when attaching the removable portion with the main portion of the printhead. The electronics interface of the given portion of the printhead can have a flat face that lies in a same plane as an exposed flat face of the removable protective plate when the removable protective plate is attached to the given portion of the printhead.

At least one of the first and second electronics can include a printed circuit board. The first and second electronics interfaces can couple with each other through spring-loaded pins.

The removable sealing member can include two or more removable sealing members. Each of the two or more removable sealing members can include at least two protruding portions.

The main portion of the printhead can include a core body and an additional module.

The additional module can be an intermediate module to which the removable portion of the printhead attaches.

All electrical connections and all hydraulic connections between the removable portion and the main portion can be formed or unformed in a single operation of attaching or detaching the removable portion of the printhead to the main portion of the printhead.

The inkjet printer can include screws for attaching the removable portion to the main portion of the printhead. The removable portion can include retainers configured to hold the screws in position on the removable portion when the removable portion is detached from the main portion of the printhead.

The flat portion can include i) a flat surface that surrounds one or more protruding portions and/or ii) a network of flat beams that interconnects two or more protruding portions. The two or more protruding portions can include at least five protruding portions.

In general, one or more aspects of the subject matter described in this specification can be embodied in one or more methods including: unforming electrical connections between first electronics of a main portion of a printhead and second electronics of a removable portion of the printhead; and unforming hydraulic connections between first fluid interface conduits of the main portion of the printhead and second fluid interface conduits of the removable portion of the printhead; wherein unforming the electrical connections and unforming the hydraulic connections can include performing a single operation of detaching the removable portion of the printhead from the main portion of the printhead.

The method can further include unscrewing one or more screws. The screws can be screws for attaching the removable portion of the printhead to the main portion of the printhead. During the single operation of detaching the removable portion to the main portion, the one or more screws can be held in position on the removable portion by a retainer.

The method can further include cleaning the removable portion of the printhead and/or the main portion of the printhead. At least one of the main portion and the removable portion can include a removable sealing member and a removable protective plate for that given portion of the printhead. The cleaning can include cleaning the removable sealing member and/or the removable protective plate.

The method can further include: forming electrical connections between first electronics of the main portion of the printhead and second electronics of the removable portion of the printhead; and forming hydraulic connections between first fluid interface conduits of the main portion of the printhead and second fluid interface conduits of the removable portion of the printhead.

Performing the single operation of detaching the removable portion of the printhead to the main portion of the printhead can include performing the single operation of detaching the removable portion of the printhead from the main portion of the printhead in a linear motion. Forming the electrical connections and forming the hydraulic connections can include performing a single operation of attaching the removable portion of the printhead to the main portion of the printhead, optionally performing the single operation of attaching the removable portion of the printhead to the main portion of the printhead in a linear motion.

The method can further include screwing one or more screws. The screws can be screws for attaching the removable portion of the printhead to the main portion of the printhead. During the single operation of attaching the removable portion to the main portion, the one or more screws can be held in position on the removable portion by a retainer.

Particular embodiments of the subject matter described in this specification can be implemented to realize one or more of the following advantages. Maintenance of printhead components can be eased. The removable portion of the printhead can be easily connected to and disconnected of the main portion of the printhead in a “plug and play” manner. Protection of electronic components and sealing of fluid connections, including connections for pressurized ink is ensured. The removable portion of a printhead can be readily exchanged while guaranteeing reliable electrical and fluidic contacts with other portions of the printhead. The interfaces between the removable portion and main portion of the printhead do not need complex parts and can be readily cleaned, for example to remove spilled ink. Sealing protection of internal parts of the printhead is ensured to protect electronics and allow cleaning of the removable portion and/or the main portion when dismounting the printhead or to limit impact if there is leakage. Sealing parts can be maintained in position during mounting and dismounting without the risk of loss of the sealing parts.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an inkjet printer.

FIG. 2 shows an example of a printhead including a main portion and a removable portion.

FIG. 3 shows a view of an example of a main portion of a printhead.

FIG. 4A shows a view of an example of a removable portion of a printhead.

FIGS. 4B-4C show details of an exploded view of an example of a removable portion of a printhead.

FIG. 4D shows an example of a removable sealing member that can be used in a printhead.

FIGS. 5A-5B show examples of printheads.

FIG. 6 is a flowchart of an example of a method that can be performed with a printhead.

Like reference numbers and designations in the various drawings indicate like elements.

### DETAILED DESCRIPTION

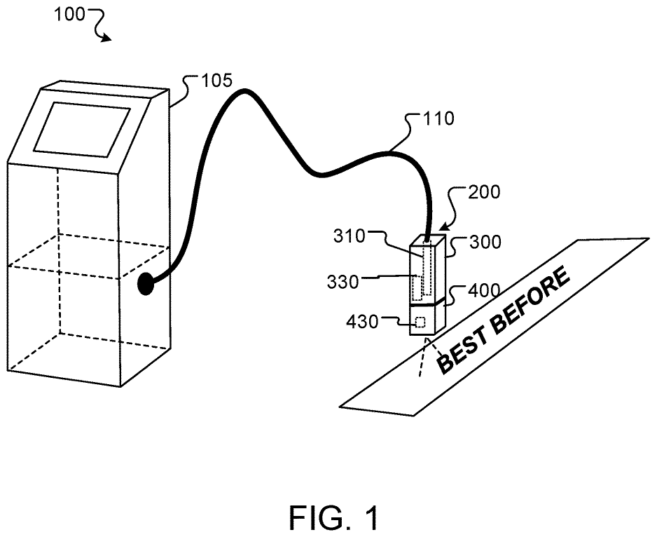

FIG. 1 shows an example of an inkjet printer 100. For example, inkjet printer 100 can be a continuous inkjet printer 100, such as a CIJ printer, a binary continuous inkjet printer, a piezo inkjet printer, a super piezo inkjet (SPI) printer, or any other type of continuous inkjet printer. Inkjet printer 100 includes a printer body 105. A printhead 200 is coupled with the printer body 105. In some examples, the printer body 105 and the printhead 200 can be coupled via an umbilical cable 110 that includes hydraulic and electrical connections required for operation of the printhead 200.

The printhead 200 includes a main portion 300 and a removable portion 400. The main portion 300 (also referred to as a printhead body module) is coupled to the printer body 105. For example, printhead 200 can be attached to the umbilical cable 110. The main portion 300 includes one or more fluid supply conduits 310 to carry at least ink for the inkjet printer 100. The main portion 300 also includes electronics 330. The removable portion 400 also includes electronics 430.

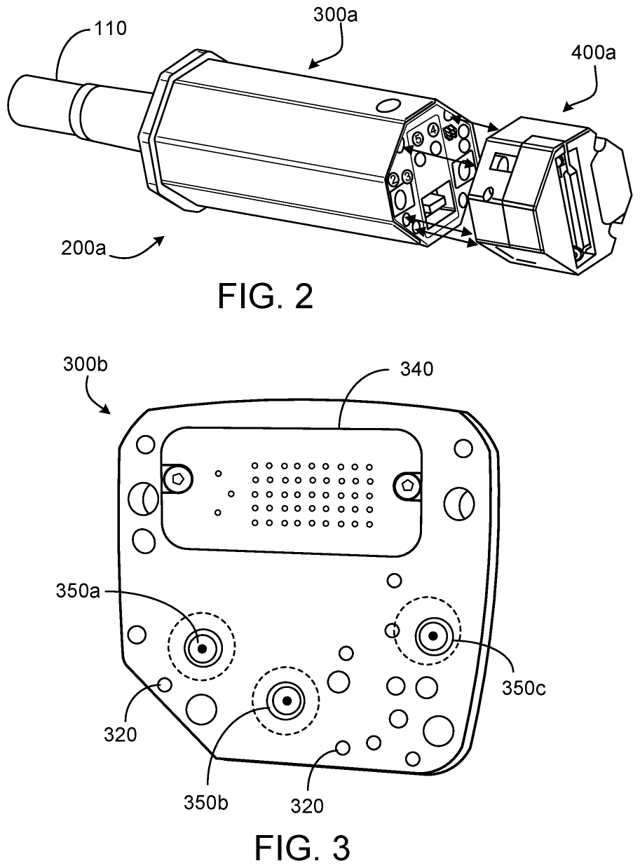

As shown in more detail in FIG. 2, the removable portion 400a (also referred to as an active module) of printhead 200a can be attached to and detached from the main portion 300a (also referred to as a printhead body module). In some examples, the removable portion 400a can include one or more of the following components: a drop generator, drop selection means (e.g., charge and deflection electrodes), sensors, inkjet recovery elements, and a cleaning system.

In some examples, the removable portion 400a (or active module) can be attached to and detached from the main portion 300a accurately in one operation, e.g., using a linear motion as shown with arrows in FIG. 2. The printhead body and the active module can be connected in a “plug and play” manner, establishing hydraulic and electric connections between the main portion 300a and the removable portion 400a in one operation.

FIG. 3 shows a view of an example of a main portion 300b of a printhead (also referred to as a printhead body module). The main portion 300b includes one or more fluid supply conduits 310 as shown in FIG. 1 (not shown in FIG. 3) to carry at least ink for the inkjet printer. Some of the one or more fluid supply conduits 310 can carry solvent or air. The main portion 300b also includes fluid interface conduits 320 coupled with the one or more fluid supply conduits 310. The main portion 300b also includes electronics 330 as shown in FIG. 1 (not shown in FIG. 3) and an electronics interface 340 coupled with the electronics 330. In some examples, the main portion can also include screws 350a, 350b, 350c to internally fix parts internal to the main portion.

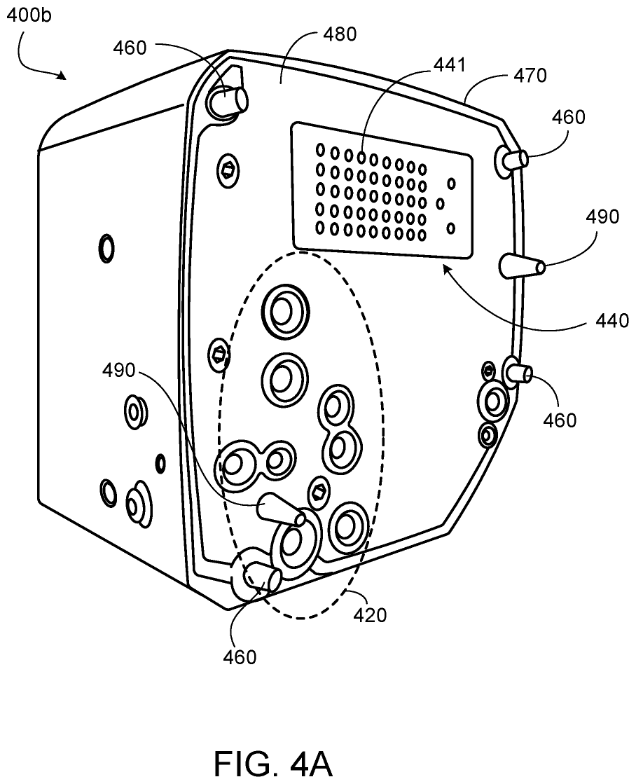

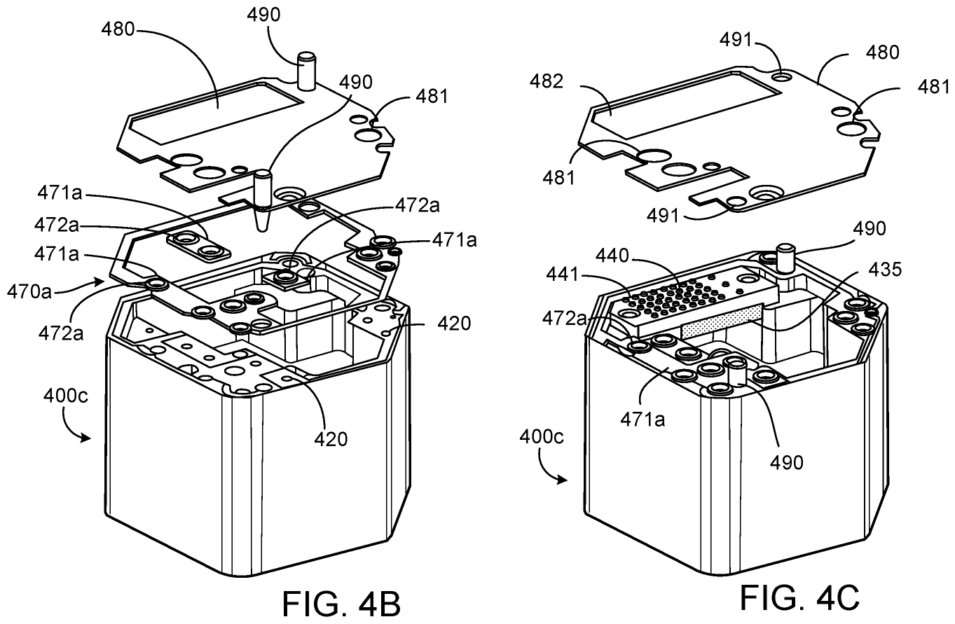

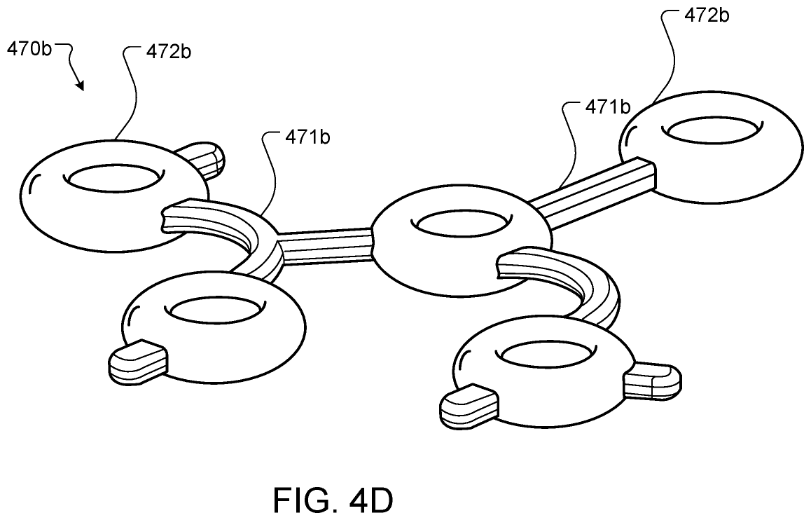

FIG. 4A shows a view of an example of a removable portion 400b. FIGS. 4B, 4C show exploded views of an example of a removable portion 400c. FIG. 4D shows an example of a removable sealing member that can be used in a printhead.

The removable portion 400b, 400c includes fluid interface conduits 420, electronics 430 as shown in FIG. 1 (not shown in FIGS. 4A-4C), and an electronics interface 440 coupled with the electronics 430.

The main portion electronics interface 340 and the removable portion electronics interface 440 are configured and arranged to connect to each other, thereby forming electrical connections between the main portion electronics 330 and the removable portion electronics 430, when the removable portion 400b is attached to the main portion 300b. In some implementations, the electrical connections are formed via spring-loaded pins. For example, pogo pins with a stroke that allows to create a surface as flat as possible can be used (e.g., Smiths C series spring probes with a stroke of 0.35 mm).

At least one of the main portion 300b and the removable portion 400b includes one or more removable sealing members 470 and a removable protective plate 480. In the examples of FIGS. 4A-4C, the removable portion 400b, 400c includes removable sealing member(s) 470 and a removable protective plate 480. Although FIGS. 4A-4C show the removable sealing member and the removable protective plate as part of the removable portion 400b, 400c any or both can be additionally or alternatively part of the main portion.

The removable sealing member(s) 470 include a flat portion 471a and protruding portions 472a, 472b. The protruding portions 472a, 472b are aligned with the fluid interface conduits of the main portion and of the removable portion such that the protruding portions form sealed hydraulic connections between the main portion fluid interface conduits and the removable portion fluid interface conduits when the removable portion is attached to the main portion. As shown in FIGS. 4B-4C, the flat portion can be a flat surface 471a. For example, flat surface 471a can be a flat surface 471a that surrounds protruding portions 472a.

As shown in FIG. 4D, additionally or alternatively, the flat portion can include a network of flat beams 471b that interconnect two or more protruding portions 472b. In some examples, the two or more protruding portions 472b can include five or more protruding portions, e.g., that seal all fluidic contacts/connections for the printhead.

In some examples, the fluid interface conduits can include one or more conduits that carry pressurized ink for ink supply to the drop generator from the main portion to the removable portion. In some examples, the fluid interface conduits can include one or more conduits for ink recovery from the removable portion back to the main portion. In some examples, the fluid interface conduits can include one or more conduits for cleaning solvent supply from the main portion to the removable portion. In some examples, the fluid interface conduits can include one or more conduits for cleaning solvent aspiration (i.e., recovery of used cleaning solvent) from the removable portion to the main portion. In some examples, the fluid interface conduits can include one or more conduits for air supply from the main portion to the removable portion.

In the examples of FIGS. 4A-4C, there is a removable sealing member 470a that surrounds the inner contour of the removable portion and includes a flat portion 471a and protruding portions 472a. In some examples, this and/or other sealing member can be made of ethylene propylene diene monomer (EPDM) rubber or other elastomeric material. In some examples, 50 Shore A EPDM is used. FIGS. 4A-4D show further removable sealing members 470a, 470b including a flat portion 471a, 471b and protruding portions 472a, 472b. In some examples, some of the fluid interface conduits can sustain high pressures, such as pressures corresponding to pressurized ink used to form the ink jet. In some examples, one or more of the sealing member(s) 470 can be made of 70 Shore A EPDM, FFKM, or other elastomeric material compatible with ink jet printing ink.

The removable protective plate 480 is positioned over the flat portion 471a, 471b of the removable sealing member(s) 470 when the removable protective plate 480 is attached to the given portion (the removable portion in this case) of the printhead. The removable protective plate defines holes 481 through which the protruding portions 472a, 472b of the removable sealing member 470a, 470b pass when the removable protective plate 480 is attached to the given portion (the removable portion in this case) of the printhead. The removable protective plate remains attached to the given portion (the removable portion in this case) of the printhead when the removable portion is not attached to the main portion.

The removable protective plate 480 can also be positioned over the electronics 430 of the given portion of the printhead when the removable protective plate 480 is attached to the given portion (the removable portion in this case) of the printhead. The removable protective plate 480 can define an additional hole 482 into which the electronics interface 440 of the given portion of the printhead is positioned when the removable protective plate is attached to the given portion of the printhead.

The described system provides protection of the electronics in case of leakage. Parts can be cleaned even when the removable portion is detached from the main portion since the electronics of the main portion is protected in case of leakage of hydraulics line. The protective plate maintains the sealing parts efficiently in position.

The removable protective plate 480 can include positioning protrusions 490 that ensure proper alignment when attaching the removable portion 400b to the main portion 300b of the printhead. In some examples, positioning protrusions 490 can be fixed to the removable portion 400c and removable plate 480 can define corresponding holes 491 to let them pass. Positioning protrusions 490 enable precise alignment of the removable portion and the main portion. This allows the use of high-density electronics connectors. The electronics interface 440 of the given portion of the printhead can have a flat face that lies in a same plane as an exposed flat face of the removable protective plate 480 when the removable protective plate 480 is attached to the given portion of the printhead. This results in a flat interface that can be easily cleaned.

At least one of main portion or removable portion electronics 330, 430 can include a printed circuit board 435. The main portion and the removable portion electronic interfaces 340, 440 can couple with each other through spring-loaded pins 441.

The removable sealing member(s) 470 can include two or more removable sealing members 470a, 470b. In some examples, each of the two or more removable sealing members can include at least one protruding portion 472a, 472b and a flat portion 471a, 471b allowing the protective plate to efficiently maintain the sealing member in position. In some examples, each of the two or more removable sealing members 470a can include at least two protruding portions 472a, 472b and a flat portion 471a, 471b. Grouping protruding portions for individual conduits together in a sealing member with a flat portion 471a, 471b allows to efficiently maintain sealing parts in position while at the same time reducing the risk of losing seals and making it easier to check that all seals are present during mounting and dismounting the active module. In some examples, the flat portion of a removable sealing member 470b can include a network of flat beams 471b that interconnect the two or more protruding portions 472b. In some examples, the two or more protruding portions 472b can include five or more protruding portions. Using a network of flat beams can reduce the risk of losing seals and making it easier to check that all seals are present during mounting and dismounting the active module while at the same time reducing the amount of material needed for the sealing member.

In some examples, all electrical connections and all hydraulic connections between the removable portion and the main portion can be formed or unformed in a single operation of attaching or detaching the removable portion of the printhead to the main portion of the printhead. In some examples, screws 460 can be included for attaching the removable portion to the main portion of the printhead. The removable portion can include one or more retainers, such as rings, washers, nuts, or the like, configured to hold the screws in position on the removable portion when the removable portion is detached from the main portion of the printhead.

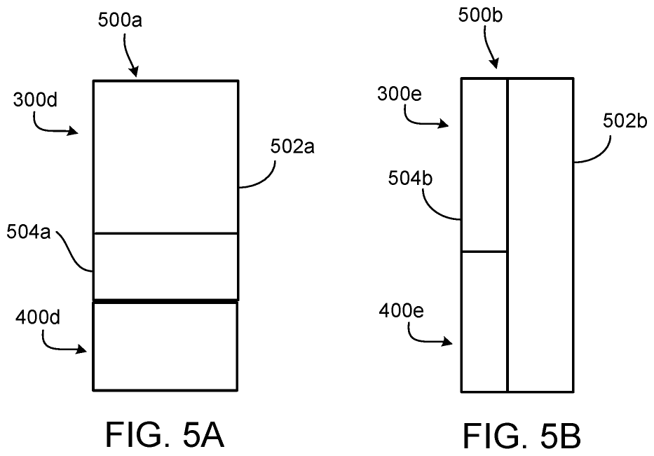

FIGS. 5A-5B show examples of printheads 500a, 500b. In some examples, the main portions 300d, 300e of the printheads 500a, 500b can include a core printhead body 502a and an additional module 504a, 504b. As shown in FIG. 5A, in some examples, the additional module 504a, 504b can be an intermediate module 504a to which a removable portion 400d of the printhead 500a can attach. As shown in FIG. 5B, in some examples, the additional module can be a parallel module 504b that attaches to a core printhead body 502b in parallel with a removable portion 400e.

The additional module 504a, 504b can include one or more electrovalves. In some examples, the additional module 504a, 504b can include a manifold and/or an ink heater. In some examples, the additional module 504a, 504b is also a removable module that can be attached to and detached to the core printhead body 502a, 502b. In some examples, the removable portion 400e and the additional module 504b can be hydraulically and/or electrically connected to each other. In some examples, the removable portion 400e and the additional module 504b can be independent modules that are not hydraulically and/or electrically connected to each other. In some examples, the additional module 504b can be protected by a cover placed on the printhead or on the additional module 504b.

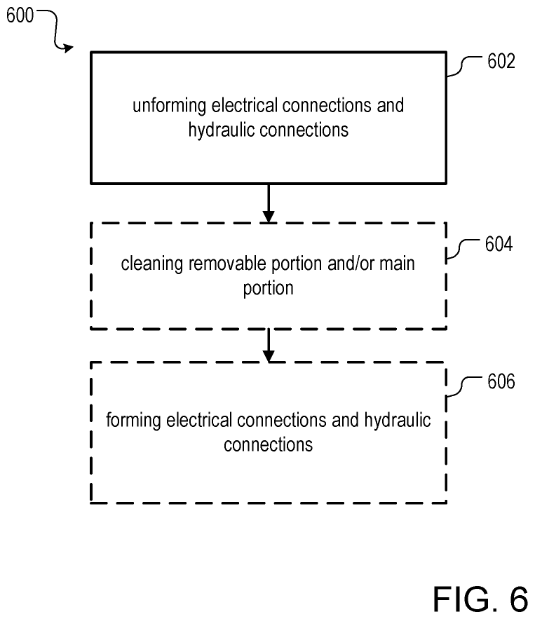

FIG. 6 shows a flowchart of an example of a method 600 that can be performed with a printhead. In some examples, method 600 includes at 602 unforming electrical connections between first electronics of a main portion of a printhead and second electronics of a removable portion of a printhead and unforming hydraulic connections between first fluid interface conduits of the main portion of the printhead and second fluid interface conduits of the removable portion of the printhead. In some examples, unforming the electrical connections and unforming the hydraulic connections includes performing a single operation of detaching the removable portion of the printhead from the main portion of the printhead to unform all electrical connections and hydraulic connections. In some examples, performing a single operation of detaching the removable portion of the printhead from the main portion of the printhead includes performing a linear motion. For example, the linear motion can be performed along a straight line between the main portion and the removable portion.

In some examples, detaching the removable portion from the main portion can include unscrewing one or more screws 460. During the single operation of detaching the removable portion to the main portion the screws can be held in position on the removable portion by a retainer.

Method 600 can optionally include cleaning 604 the removable portion and/or the main portion of the printhead. As described above, the interfaces between the removable portion and main portion of the printhead do not need complex parts and can be readily cleaned, for example to remove spilled ink. Sealing protection of internal parts of the printhead is ensured to allow cleaning of the removable portion and/or the main portion when dismounting the printhead and to limit impact if there is leakage. Further, sealing parts can be maintained in position during mounting and dismounting without the risk of loss of the sealing parts.

Method 600 can optionally include forming 606 electrical connections between first electronics of a main portion of a printhead and second electronics of a removable portion of a printhead and forming hydraulic connections between first fluid interface conduits of the main portion of the printhead and second fluid interface conduits of the removable portion of the printhead. In some examples, forming the electrical connections and forming the hydraulic connections includes performing a single operation of attaching the removable portion of the printhead to the main portion of the printhead to form all electrical connections and hydraulic connections. The single operation can include a linear motion operation. For example, the linear motion can be performed along a straight line between the main portion and the removable portion.

In some examples, attaching the removable portion to the main portion can include screwing one or more screws 460. During the single operation of attaching the removable portion to the main portion the screws can be held in position on the removable portion by one or more retainers.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the invention have been described. Other embodiments are within the scope of the following claims. In addition, actions recited in the claims can be performed in a different order and still achieve desirable results.

1. An inkjet printer comprising:
a printer body; and
a printhead coupled with the printer body, the printhead comprising a main portion and a removable portion, wherein
the main portion comprises one or more fluid supply conduits to carry at least ink for the inkjet printer, first fluid interface conduits coupled with the one or more fluid supply conduits, first electronics, and a first electronics interface coupled with the first electronics,
the removable portion comprises second fluid interface conduits, second electronics, and a second electronics interface coupled with the second electronics,
the first and second electronics interfaces are configured and arranged to connect to each other, thereby forming electrical connections between the first and second electronics, when the removable portion is attached to the main portion,
at least one of the main portion and the removable portion comprises a removable sealing member and a removable protective plate for that given portion of the printhead,
the removable sealing member comprises a flat portion and protruding portions, the protruding portions being aligned with the first and second fluid interface conduits such that the protruding portions form sealed hydraulic connections between the first and second fluid interface conduits when the removable portion is attached to the main portion, and the removable protective plate is positioned over the flat portion of the
removable sealing member when the removable protective plate is attached to the given portion of the printhead, the removable protective plate remains attached to the given portion of the printhead when the removable portion is not attached to the main portion, and the removable protective plate defines holes through which the protruding portions of the removable sealing member pass when the removable protective plate is attached to the given portion of the printhead.

2. The inkjet printer of claim 1, wherein the removable protective plate is also positioned over the electronics of the given portion of the printhead when the removable protective plate is attached to the given portion of the printhead, and the removable protective plate defines an additional hole into which the electronics interface of the given portion of the printhead is positioned when the removable protective plate is attached to the given portion of the printhead.

3. The inkjet printer of claim 2, wherein the removable protective plate comprises positioning protrusions or defines holes for positioning protrusions that ensure proper alignment when attaching the removable portion with the main portion of the printhead, and the electronics interface of the given portion of the printhead has a flat face that lies in a same plane as an exposed flat face of the removable protective plate when the removable protective plate is attached to the given portion of the printhead.

4. The inkjet printer of claim 3, wherein at least one of the first and second electronics comprises a printed circuit board, and the first and second electronics interfaces couple with each other through spring-loaded pins.

5. The inkjet printer of claim 1, wherein the removable sealing member comprises two or more removable sealing members, and each of the two or more removable sealing members comprises at least two protruding portions.

6. The inkjet printer of claim 1, wherein the main portion of the printhead comprises a core body and an additional module.

7. The inkjet printer of claim 6, wherein the additional module is an intermediate module to which the removable portion of the printhead attaches.

8. The inkjet printer of claim 1, wherein all electrical connections and all hydraulic connections between the removable portion and the main portion are formed or unformed in a single operation of attaching or detaching the removable portion of the printhead to the main portion of the printhead.

9. The inkjet printer of claim 8, comprising screws for attaching the removable portion to the main portion of the printhead, wherein the removable portion comprises retainers configured to hold the screws in position on the removable portion when the removable portion is detached from the main portion of the printhead.

10. The inkjet printer of claim 1, wherein the flat portion comprises i) a flat surface that surrounds one or more protruding portions and/or ii) a network of flat beams that interconnects two or more protruding portions.

11. The inkjet printer of claim 10, wherein the flat portion comprises the network of flat beams that interconnects the two or more protruding portions, and wherein the two or more protruding portions comprise at least five protruding portions.

12. A method comprising:
unforming electrical connections between first electronics of a main portion of a printhead and second electronics of a removable portion of the printhead; and
unforming hydraulic connections between first fluid interface conduits of the main portion of the printhead and second fluid interface conduits of the removable portion of the printhead;
wherein unforming the electrical connections and unforming the hydraulic connections comprises performing a single operation of detaching the removable portion of the printhead from the main portion of the printhead.

13. The method of claim 12, further comprising unscrewing one or more screws, wherein the screws are screws for attaching the removable portion of the printhead to the main portion of the printhead, and wherein, during the single operation of detaching the removable portion to the main portion, the one or more screws are held in position on the removable portion by a retainer.

14. The method of claim 13, further comprising cleaning the removable portion of the printhead and/or the main portion of the printhead.

15. The method of claim 14, wherein at least one of the main portion and the removable portion comprises a removable sealing member and a removable protective plate for that given portion of the printhead, and wherein the cleaning comprises cleaning the removable sealing member and/or the removable protective plate.

16. The method of claim 12, wherein performing the single operation of detaching the removable portion of the printhead to the main portion of the printhead comprises performing the single operation of detaching the removable portion of the printhead from the main portion of the printhead in a linear motion.

17. The method of claim 12, further comprising:
forming electrical connections between first electronics of the main portion of the printhead and second electronics of the removable portion of the printhead; and
forming hydraulic connections between first fluid interface conduits of the main portion of the printhead and second fluid interface conduits of the removable portion of the printhead.

18. The method of claim 17, wherein forming the electrical connections and forming the hydraulic connections comprises performing a single operation of attaching the removable portion of the printhead to the main portion of the printhead, optionally performing the single operation of attaching the removable portion of the printhead to the main portion of the printhead in a linear motion.

19. The method of claim 12, further comprising screwing one or more screws, wherein the screws are screws for attaching the removable portion of the printhead to the main portion of the printhead, and wherein, during the single operation of attaching the removable portion to the main portion, the one or more screws are held in position on the removable portion by a retainer.
